(19) United States
(12) Patent Application Publication
(10) Pub. No.: US 2008/0139293 A1
(43) Pub. Date: Jun. 12, 2008

(54) Gaming machine

(75) Inventor: Kazunobu Sato, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/907,100

(22) Filed: Oct. 9, 2007

(30) Foreign Application Priority Data
Oct. 10, 2006 (JP) P2006-276169

(51) Int. Cl. A63F 13/00

(52) U.S. Cl. 463/20

(57) ABSTRACT

A gaming machine includes: a display; an operation unit that allows a player to input commands for playing a game; and a processor that operates to: control the display to perform a variable display of a plurality of symbols in each of a plurality of variable display sections that are arranged in matrix, when a start command is input through the operation unit; perform a lottery to determine stop symbols to be displayed stopped in the variable display sections; control the display to display the stop symbols in the variable display sections after performing the variable display; determine whether or not a symbol combination of the stop symbols satisfies a winning combination; provide an award to the player when determined that the symbol combination of the stop symbols satisfies the winning combination; determine variable display section identifying information for each of the variable display sections; provide a special award to the player based on the determined variable display section identifying information, the special award being advantageous to the player.

### CROSS-REFERENCE TO THE RELATED APPLICATION(S)

The present application is based upon and claims priority from prior Japanese Patent Application No. 2006-276169, filed on Oct. 10, 2006, the entire content of which are incorporated herein by reference.

### TECHNICAL FIELD

The present invention relates to a gaming machine that variably displays a plurality of symbols in each of a plurality of variable display sections.

### BACKGROUND

As the popularity of gaming machines increases recently, various types of gaming machines have been developed and emerged in the market. Among these gaming machines, many types of gaming machines, in which nine reels are disposed in a 3×3 matrix and total of eight pay lines including three vertical pay lines, three horizontal pay lines, and two diagonal pay lines are provided, have been developed and emerged in the market.

Generally, gaming machines pay out awards to players when symbol combinations stopped on pay lines satisfies winning combinations. However, in order to further improve the enthusiasm of players for games, gaming machines having a type of bonus (also called “Mystery Feature”), which is awarded unexpectedly when a predetermined condition not clarified to the gamers is satisfied, in addition to winning combinations on pay lines have been developed (for example, JP-A-2004-057221, also published as U.S. Pat. No. 6,893,018 B1).

As gaming machines that provide this type of bonus, in order to diversify the games, gaming machines having a bonus (also called “Mystery Odds”) that makes an ordinary award two times to five times when a predetermined condition is satisfied have been proposed (for example, JP-A-2003-180908, also published as US 2003/0130027 A1). This type of gaming machines provide excellent stimulus to the players in a relatively monotonous video slot games, and since games having the “Mystery Odds” can improve the expectation of the players, entertaining features of the games become excellent, whereby the gaming machines become very popular.

However, when the type of bonus disclosed in JP-A-2003-180908 is provided in a gaming machine, the awards are increased two times to five times while the occurrence probability of the winning combinations is the same as a conventional case. Thus, the amounts of payouts for the awards abruptly change and games provided by the gaming machine become high-risk gambling games, which is not appropriate for a gaming machine having moderate payouts.

### SUMMARY

One of objects of the present invention is to provide a gaming machine capable of performing moderate payouts while increasing the expectation for acquisition of a large quantity of coins similar to the conventional “Mystery Odds” and provides a surprise for unexpected awards.

According to a first aspect of the invention, there is provided a gaming machine including: a display; an operation unit that allows a player to input commands for playing a game; and a processor that operates to: control the display to perform a variable display of a plurality of symbols in each of a plurality of variable display sections that are arranged in matrix, when a start command is input through the operation unit; perform a lottery to determine stop symbols to be displayed stopped in the variable display sections; control the display to display the stop symbols in the variable display sections after performing the variable display; determine whether or not a symbol combination of the stop symbols satisfies a winning combination; provide an award to the player when determined that the symbol combination of the stop symbols satisfies the winning combination; determine variable display section identifying information for each of the variable display sections; provide a special award to the player based on the determined variable display section identifying information, the special award being

According to a second aspect of the invention, there is provided a gaming machine including: a plurality of variable display sections that display stop symbols after variably displaying a plurality of symbols; a lottery means for performing a lottery for determining the stop symbols to be displayed in the plurality of variable display sections; a determination means for determining whether or not the stop symbols displayed on the plurality of variable display sections include a symbol combination forming a winning combination on the basis of the stop symbols determined by the lottery means; an award providing means for providing an award corresponding to the winning combination when the determination means determines that the stop symbols displayed on the plurality of variable display sections include the symbol combination forming the winning combination; a determination means for determining variable display section identifying information for each of the plurality of variable display sections; and a special advantage awarding means for providing a special advantage that is advantageous to a player on the basis of the variable display section identifying information determined by the determination means.

### BRIEF DESCRIPTION OF THE DRAWINGS

In the accompanying drawings:

FIG. 1 is a perspective view showing the overall appearance of a slot machine as a gaming machine according to an embodiment of the present invention;

FIG. 2 is a block diagram of the slot machine showing the configuration of its internal control system as an example;

FIG. 3 shows a block diagram of a video controller of the slot machine showing its internal configuration as an example;

FIG. 4 is a flowchart showing a main process that is an operational flow from the start to the end of a game in the slot machine;

FIG. 5 is a flowchart showing an operational flow of a base game process;

FIG. 6 is a diagram showing a stop table as an example;

FIG. 7 shows the configuration of a game screen displayed in the slot machine;

FIG. 8 is a flowchart showing an example of an operational flow of a special advantage process;

FIG. 9 is a flowchart showing an operational flow of a bonus game process as an example;

FIG. 10 is a diagram showing an example of a screen in a status that colors of frames are displayed;

FIG. 11 is a diagram showing relationship between hatchings shown in FIG. 10 and colors;

FIG. 12 is a diagram showing an example of a screen in a status that colors of the frames, for which an identification combination is achieved, are displayed;

FIG. 13 is a diagram showing an example of a screen in a status that colors of the frames, for which an identification combination is achieved, are displayed; and

FIG. 14 is a diagram showing an example of a screen in a status that colors of the frames, for which an identification combination is achieved, are displayed.

### DETAILED DESCRIPTION

Hereinafter, an embodiment of the present invention will be described. In the following description, parts substantially the same are denoted with same reference symbols, and redundant explanation will be omitted.

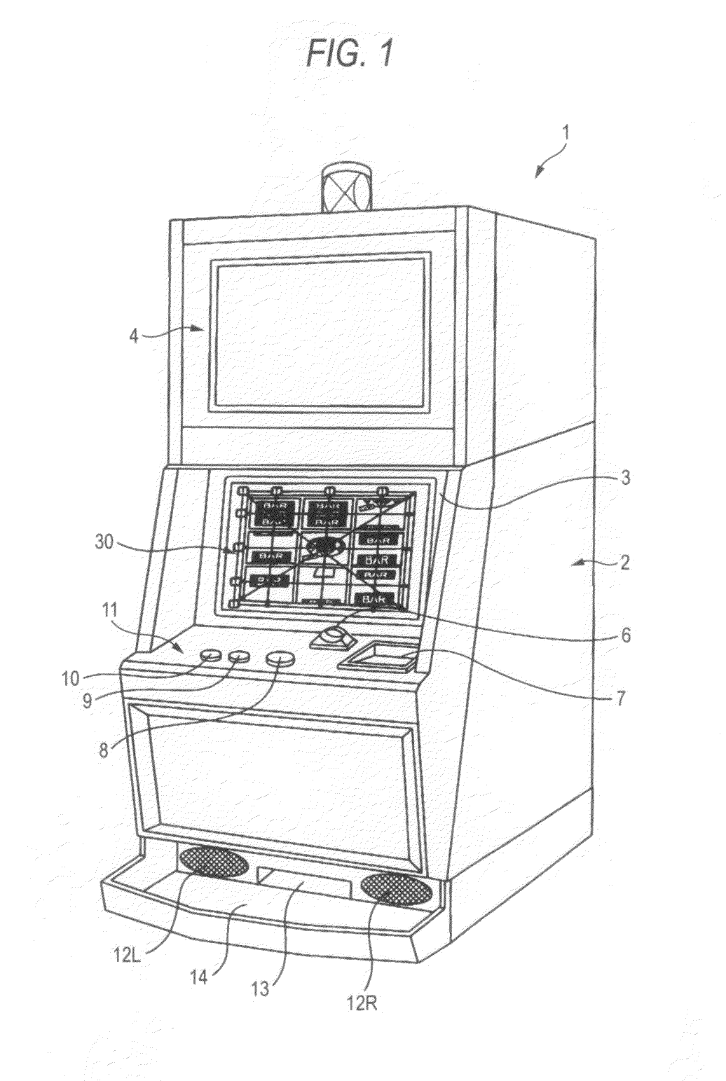

FIG. 1 is a perspective view showing the overall appearance of a slot machine 1. The slot machine 1 is a gaming machine according to an embodiment of the present invention and is configured to perform a variable display game (also referred to as a slot game) using variable display images of a plurality of symbols. The slot machine 1 has a base game mode in which a base game (a base game according to an embodiment of the present invention) started by default from the start of an operation thereof is performed and a bonus game mode in which a bonus game started under a predetermined condition after the base game is performed. The slot machine 1 is configured to be able to perform a variable display game additionally in the bonus game mode. The slot machine 1 is configured to perform a variable display section game parallel or consecutively with a variable display game in the base game mode and the bonus game mode.

The slot machine 1 has a main display 3 including a liquid crystal device on the front side of a casing 2. In addition, the slot machine 1 has a sub-display 4 including a liquid crystal device likewise above the main display 3.

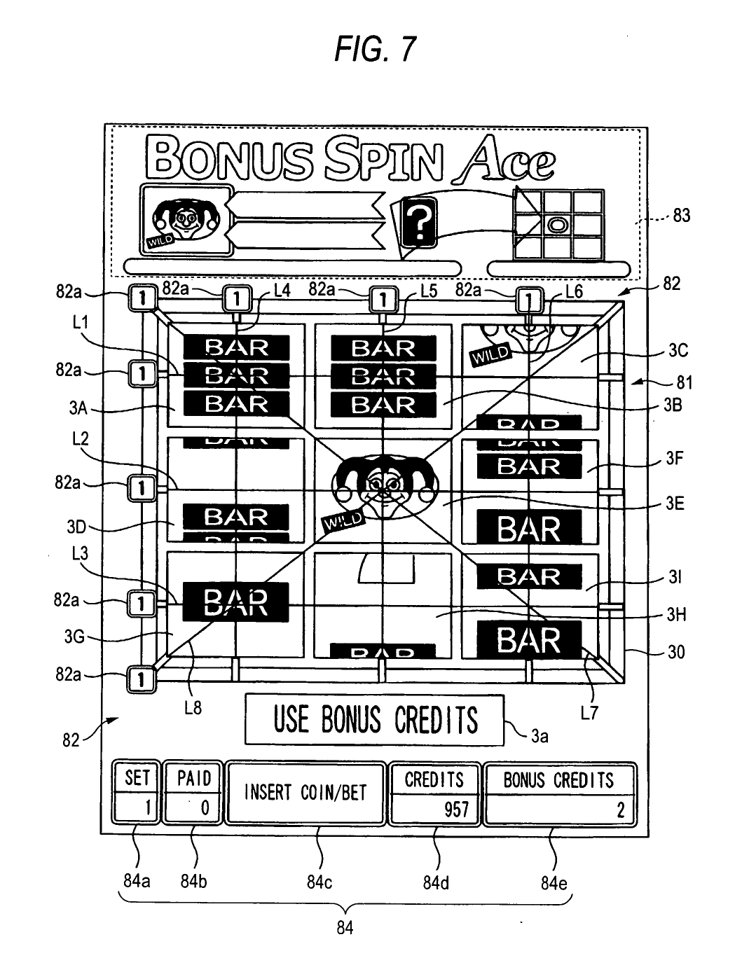

In the approximately center of the screen of the main display 3, a variable display area 30 is provided. This variable display area 30, as shown in FIG. 7 to be described later, has a plurality of variable display sections (in the embodiment, total nine variable display sections 3A, 3B, 3C, 3D, 3E, 3F, 3G, 3H, and 3I disposed in horizontal three rows X vertical three columns). A scrolling image (an image displayed as if a mechanical reel rotates), in which a plurality of symbols look as if they move from top to bottom are displayed, is configured to be displayed in the variable display sections 3A to 3I included in the variable display area 30 of the main display 3 in both the base game mode and the bonus game mode.

As shown in FIG. 7, since the slot machine 1 has nine variable display sections 3A to 3I, total of eight pay lines L1 to L8 including six lines constituted by three vertical columns and horizontal three rows of the variable display sections 3A to 3I and two diagonal lines of the 3×3 matrix are set.

On the sub-display 4, various information related to the game (for example, a description of game rules, an award table, description of a game) are displayed.

In the slot machine 1, a pedestal portion 11 having substantially horizontal surface is provided at a position lower than the main display 3 is provided. The pedestal portion 11 is provided with a coin insertion slot 6, a bill insertion slot 7, a spin button 8, a 1-BET switch 9, and a MAX-BET switch 10.

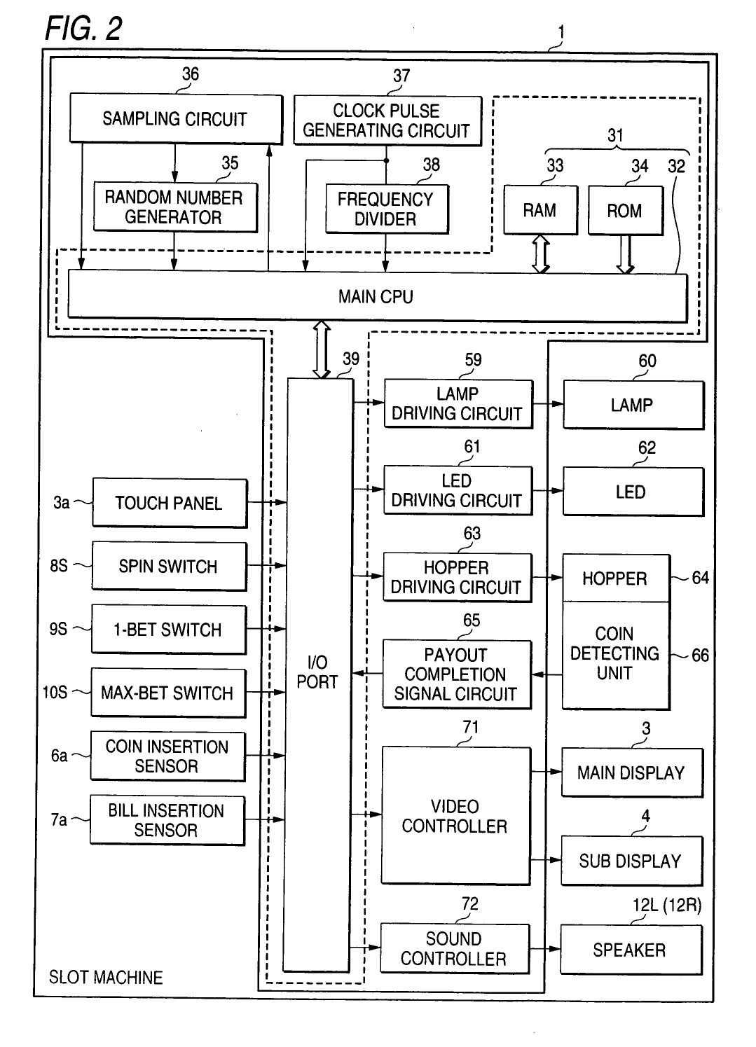

The coin insertion slot 6 is provided for the player to insert a game medium such as a coin, a medal, a token, a credit, or the like (hereinafter, simply referred to as a coin) to be bet in a game, and has a coin insertion sensor 6S (see FIG. 2) for transmitting a signal indicative of coin insertion. The bill insertion slot 7 is provided for reception of bills inserted by the player, and has a bill insertion sensor 7S (see FIG. 2) for transmitting a signal indicative of bill insertion. The spin button 8 is provided for the player to perform an operation to start a slot game by displaying scrolling display images of the symbols in the variable display sections 3A to 3I, and has a spin switch 8S (see FIG. 2) for indicating detection of press-down of the spin button 8.

The 1-BET button 9 is provided for placing a bet of one coin in a single operation, and has a 1-BET switch 9S (see FIG. 2) indicating detection of press-down of the 1-BET button 9. The MAX-BET button 10 is provided for placing a bet of the maximum number (for example, five) of coins for one game in a single operation, and has a MAX-BET switch 10S (see FIG. 2) indicating detection of press-down of the MAX-BET button 10.

In addition, the slot machine 1 includes a coin payout opening 13 and a coin receiving tray 14 for receiving coins paid out which are provided on a lower side of the casing 2. Furthermore, speakers 12L and 12R are provided on the left and right sides of the coin payout opening 13.

FIG. 2 is a block diagram of the slot machine 1 showing its internal control system as an example. The slot machine 1 includes a plurality of components with a microcomputer 31 serving as a core.

The microcomputer 31 includes a main CPU (Central Processing Unit) 32, a RAM (Random Access Memory) 33, and a ROM (Read Only Memory) 34. The main CPU 32 operates as various means featuring the invention based on a program stored in the ROM 34, transmits/receives signals to/from the other components via an I/O port 39, and controls operations of the entire slot machine 1. The RAM 33 stores data and programs which are used when the MAIN CPU 32 is in operation. For example, the RAM 33 temporarily retains random number values sampled by a sampling circuit 36 to be described later, after the game starts. The ROM 34 stores programs to be executed by the main CPU 32 and permanent data.

The slot machine 1 includes a random number generator 35, the sampling circuit 36, a clock pulse generating circuit 37, and a frequency divider 38. The random number generator 35 operates in accordance with an instruction from the main CPU 32 and generates random numbers in a predetermined range. The sampling circuit 36, in accordance with an instruction from the main CPU 32, extracts an arbitrary random number from among the random numbers generated by the random number generator 35 and inputs the extracted random number to the main CPU 32. The clock pulse generating circuit 37 generates a reference clock for operating the main CPU 32, and the frequency divider 38 inputs a signal obtained by dividing the reference clock by a fixed frequency to the main CPU 32.

In addition, the slot machine 1 includes a touch panel 3a, a lamp driving circuit 59, a lamp 60, a LED driving circuit 61, an LED 62, a hopper driving circuit 63, a hopper 64, a payout completion signal circuit 65, and a coin detecting unit 66. In addition, the slot machine 1 includes a video controller 71 and a sound controller 72.

The touch panel 3a is provided so as to cover a display screen of the main display 3. The touch panel 3a detects a position of a spot on the display screen which is touched by a finger of the player and inputs a position signal corresponding to the detected position to the main CPU 32. The lamp driving circuit 59 outputs a signal for turning the lamp 60 on/off to the lamp 60, and thereby blinking the lamp 60 in the game. By the blinking of the lamp 60, various effects pertaining to the game is performed. The LED driving circuit 61 generates a driving control signal for controlling the blinking of the LED 62 and outputs the driving control signal to the LED 62. The LED 62 displays the number of credits, the number of acquired credits, or the like in accordance with the driving control signal output from the LED driving circuit 61. The hopper driving circuit 63 drives a hopper 64 in accordance with the control of the main CPU 32. The hopper 64 performs an operation for paying out awarded coins and pays out the coins to the coin receiving tray 14 from the payout opening. The coin detecting unit 66 counts the number of coins paid out by the hopper 64 and inputs data for the counted number of coins to the payout completion signal circuit 65. The payout completion signal circuit 65 receives the data for the number of coins input from the coin detecting circuit 66. Then, the payout completion signal circuit 65 inputs a signal indicative of completion of coin payout to the main CPU 32 when the number of the coins reaches a predetermined number.

Here, although the touch panel 3a, the spin switch 8S, the 1-BET switch 9S, the MAX-BET switch 10S, the coin insertion sensor 6S, and the bill insertion sensor 7S are directly connected to the I/O port 39 for performing input/output (transmission/reception) operations of signals, a subsidiary circuit board (door PCB (Printed Circuit Board)) may be inserted therebetween (between the touch panel 3a or the like and the I/O port 39) so as to identify a source of a signal such as the touch panel 3a or the like and the signal may be input/output (transmitted/received) to/from the main CPU 32 by the IO port 39. Similarly, a main circuit board (door PCB (Printed Circuit Board)) may be inserted between the various circuits 59, 61, 63, 65, 71, and 72 disposed on the main body side and the I/O port 39. In such a case, since only signals in use from among signals output from various switches and circuits are transmitted to the main CPU 32 through the I/O port 39, it is possible to reduce a processing load of the main CPU 32 and increase the transmission speed of signals.

The video controller 71 controls image display operations of the main display 3 and the sub display 4 and displays various images such as variable display images of a plurality of symbols, a sub game preparing screen, or the like on the main display 3 and the sub display 4.

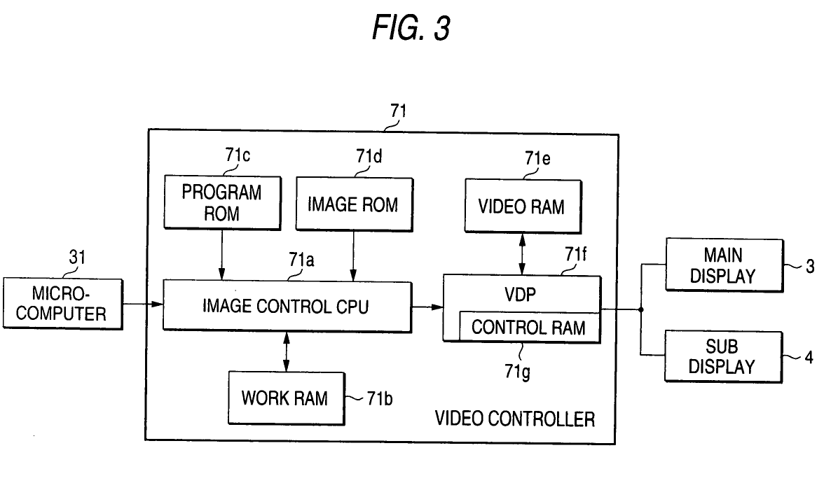

FIG. 3 shows a functional block diagram of the video controller 71 showing its configuration as an example.

As shown in FIG. 3, the video controller 71 includes an image control CPU 71a, a work RAM 71b, a program ROM 71c, an image ROM 71d, a video RAM 71e, and a VDP (Video Display Processor) 71f. The image control CPU 71a, based on a parameter set by the microcomputer 31, determines an image (a reel image, an image of a stop symbol displayed at a time when the scroll display stops, a frame that is variable display section identification information, or the like) to be displayed on the main display 3 and the sub display 4 in accordance with an image control program (regarding the display on the main display 3 and the sub display 4) stored in the program ROM 71c in advance. The work RAM 71b is configured as a temporary storage to be used at a time when the image control CPU 71a executes the image control program.

The program ROM 71c stores the image control program, various selection tables, and the like. The image ROM 71d stores dot data (bitmap data) for forming an image. In the embodiment, symbol image data representing symbols used in the base game and the bonus game is included in the dot data. The video RAM 71e is configured as a temporary storage used for the VDP 71f to form an image. The VDP 71f includes a control RAM 71g. The VDP 71f forms images on the basis of the images to be displayed on the main display 3 and the sub display 4 which have been determined by the image control CPU 71a, and outputs the formed images to the main display 3 and the sub display 4.

The description of the configuration of the slot machine 1 will now be continued with reference back to FIG. 2.

The sound controller 72 outputs a sound signal, which is used for outputting a voice, music, effect sound, or the like from the speakers 12L and 12R, to the speakers 12L and 12R. From the speakers 12L and 12R, for example, a voice, music, effect sound, or the like is output to add excitement to the game at an appropriate time after the game starts.

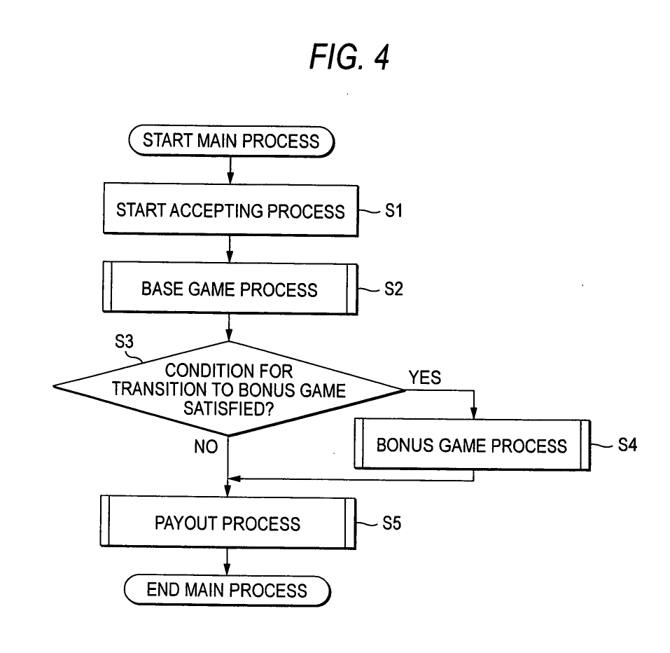

The operation of the slot machine 1 having the aforementioned configuration will now be described with reference to a flowchart shown in FIG. 4.

FIG. 4 is a flowchart showing an operational flow of a main process from the start to the end of a single round of a game (unit game) in the slot machine 1. In FIG. 4 and thereafter, the term “Step” is abbreviated as “S”.

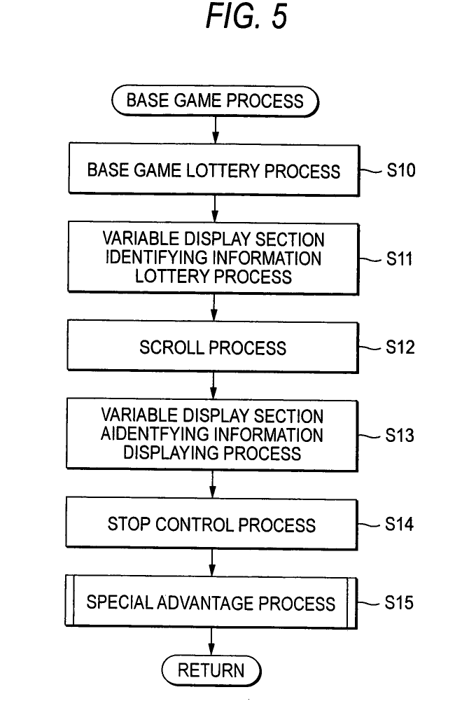

In the slot machine 1, the main CPU 32 operates as a game progress controller so as to control the progress of a game. When the slot machine 1, more particularly, the main CPU 32, starts the main process as shown in FIG. 4, in the start of the game, a start accepting process (S1) is performed at the start of the game in Step 1, a base game process (S2) is performed in the subsequent Step 2 while a base game mode is maintained as a gaming mode, and the process proceeds to Step 3. In Step 3, after receiving a result of a base game lottery process (FIG. 5; S10), to be described later, in the base game process of Step 2, the main CPU 32 determines whether to make a transition of the gaming mode to a bonus game mode on the basis of a transition condition set for transition of the gaming mode to the bonus game mode (S3). When the slot machine 1, more particularly, the main CPU 32, determines that the transition condition is satisfied (S3: Yes), the process proceeds to a bonus game process of Step 4, and then, the process proceeds to a payout process of Step 5. On the other hand, when it is determined that the transition condition is not satisfied in Step 3 (S3: No), the slot machine 1, more particularly, the main CPU 32, proceeds the process to the payout process of Step 5 without performing the bonus game process of Step 4. In the payout process of Step 5, when a wining combination is generated in the base game or the bonus game, the slot machine 1, more particularly, the main CPU 32, performs a coin payout process (a process of instructing the hopper driving circuit 63 to payout coins corresponding to the number of paying-out coins performed by the main CPU 32, and a process of paying out the coins performed by the hopper 64, and a process of inputting a signal from the payout completion signal circuit 65) in accordance with the wining combination and then ends the main process.

Hereinafter, the above-described Steps will be described in detail.

When the process proceeds to the start accepting process of Step 1, first, the slot machine 1 accepts an operation for start of the game from the player in accordance with control of the main CPU 32. Since the slot machine 1 is a coin-operated game machine, in order to start a game, the player first inserts the number of coins to be bet in one round (unit) of the game into the coin insertion slot 6 or operates the 1-BET button 9 or the MAX-BET button 10 in a case where there are remaining credits. Thereafter, the player performs an operation of the spin button 8 (hereinafter, referred to as a start operation). By performing the start operation, a start signal output from the spin switch 8S which has detected the press-down of the spin button 8 is input to the main CPU 32.

Thereafter, the process proceeds to Step 2, and the slot machine 1, more particularly, the main CPU 32, performs a base game process. FIG. 5 is a flowchart showing the base game process as an example. Hereinafter, the base game process will be described with reference to FIG. 5.

When the process proceeds to the base game process, the slot machine 1, more particularly, the main CPU 32, which serves as a lottery means according to an embodiment of the present invention, first performs a base game lottery process (S10). In the base game lottery process, the main CPU 32 is operated as a symbol determination means and performs a process of determination of the symbol. In this symbol determination process, the main CPU 32 determines the symbols (hereinafter, this symbols are referred to as stop symbols) to be stopped for being displayed by stopping variable display of the symbols on the variable display sections 3A to 3I. Whether the stop symbols satisfy a wining combination depends on whether the stop symbols on the pay lines L1 to L8 form predetermined combinations.

The main CPU 32 of the slot machine 1 instructs the video controller 71 during the base game lottery process (S10) so as to display an image (hereinafter, referred to as a representation image) for representation of the game in the sub display 4.

In the base game lottery process, when detecting the player's start operation on the basis of the start signal, the CPU 32 instructs the random number generator 35 to generate random numbers in a predetermined range in accordance with the detection (that is, in accordance with the start of the game). Then, the main CPU 32 instructs the sampling circuit 36 to extract an arbitrary random number from among the random numbers generated by the random number generator 35. When the random number is extracted, the main CPU 32 acquires a code number of a symbol corresponding to the extracted random number with reference to a symbol determining table (a table in which code numbers (hereinafter, simply referred to as numbers) of symbols linked with random numbers are stored) stored in the ROM 34 by using the random number as a search key.

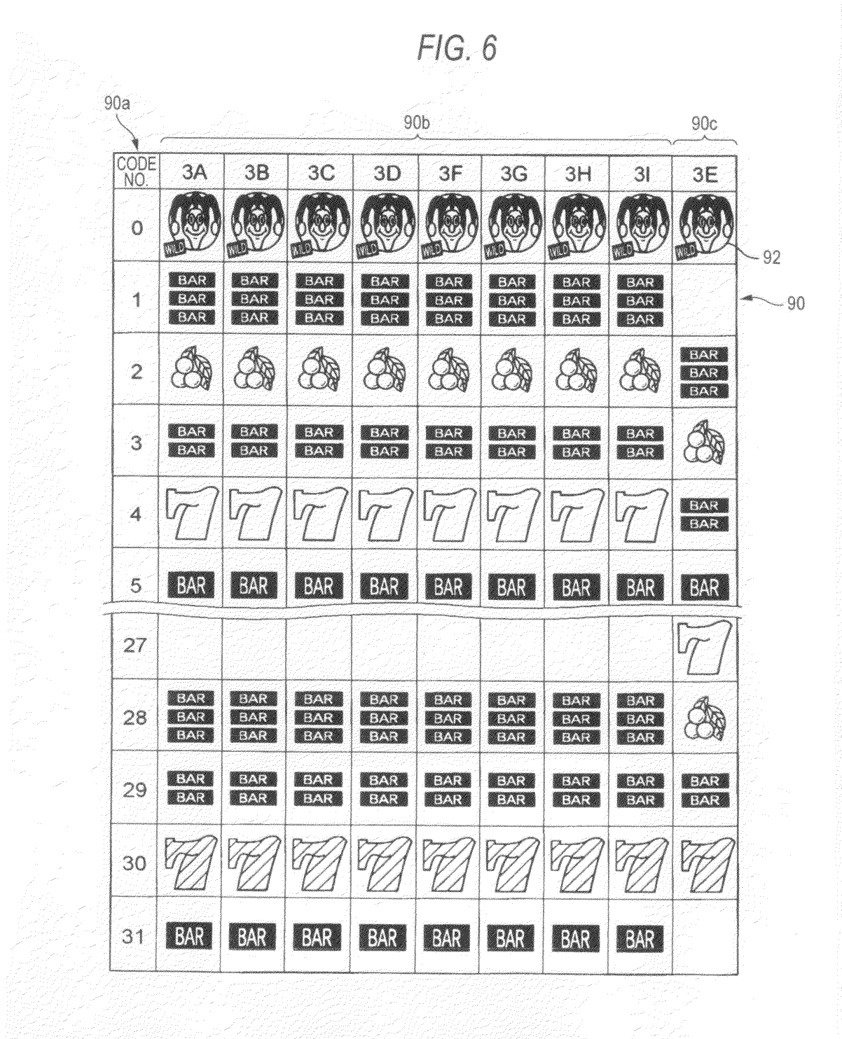

Next, the slot machine 1, more particularly, the main CPU 32, searches for stop symbols to be stopped for being displayed in the variable display sections 3A to 3I with reference to a stop table 90 shown in FIG. 6 using the acquired code number as a search key.

Now, the configuration of the stop table 90 will be described with reference to FIG. 6. The stop table 90, as shown in FIG. 6, includes a code number area 90a for storage of code numbers of the symbols and a first symbol area 90b and a second symbol area 90c which are used for storage of symbols (or file names of the symbols corresponding to the code numbers, addresses of file storing places of the symbols, file paths of the symbols, or the like). The stop table 90 is configured such that symbols for the variable display sections 3A to 3I can be found by searching the code number area 90a using the code number as the search key.

In the first symbol area 90b and the second symbol area 90c, symbols (or codes of the symbols) are registered in correspondence with code numbers of “0” to “31”. In the first symbol area 90b, stop symbols to be displayed in variable display sections 3A to 3D and 3F to 3I other than a center variable display section 3E are registered. In the second symbol area 90c, stop symbols (or codes of the stop symbols) to be stopped for being displayed in the center variable display section 3E are registered. In the embodiment, a symbol (Wild Joker 92) corresponding to a code number “0” of the second symbol area 90c is configured as a beneficial symbol. This “Wild Joker” 92 indicates a symbol more beneficial than any other symbol to the player and, as shown in FIG. 6, is composed of an image representing a doll's face and a text string of “Wild”.

The slot machine 1 performs total of nine times of the operation for extraction of random numbers and the operation for search of the symbol determining table and the stop table 90 for each of the variable display sections 3A to 3I. In other words, the operation for search of the tables is performed the number of times corresponding to the number of the variable display sections, and thereby the stop symbols for the variable display sections 3A to 3I are determined.

When the stop symbols for the variable display sections 3A to 3I are determined, the main CPU 32, which also serves as determination means according to an embodiment of the present invention, determines whether an award is won with reference to a winning determining table (not shown in the figure) stored in the ROM 34. In the winning determining table, symbol patterns are registered with being linked with combinations (hereinafter, referred to as code number patterns) of code numbers such that determination on whether a code number pattern is a winning symbol pattern or a non-winning symbol pattern can be made for determining award win.

Since the code number pattern corresponding to the stop symbols has been determined, the main CPU 32 is operated as the determination means and refers to the winning determining table by using the code number pattern corresponding to the stop symbols as the search key, and determines whether a wining combination has been satisfied in the variable display game.

Then, a winning state determination process in which the main CPU 32 determines a winning state with reference to a state table (not shown in the figure) is performed (the winning state is also called a winning combination). The state table is used for determination of a state (winning state) from among the winning combinations. In the state table, awards for the winning combination are registered.

When the winning state determination process is completed, the base game lottery process (S10) ends.

The winning combination determination process and the winning state determination process may not be performed in the base game lottery process (S10), and may be performed in a latter special advantage process (S14).

Now, the description of the base game process will be continued with reference back to FIG. 5.

After the base game lottery process (S10) is performed, the slot machine 1, more particularly, the main CPU 32, serving as identification information determination means according to an embodiment of the present invention performs a variable display section identifying information lottery process (S11). In this variable display section identifying information lottery process, the slot machine 1, more particularly, the main CPU 32, determines variable display section identifying information of the variable display sections 3A to 3I by performing lotteries. In the embodiment, it is assumed that the variable display section identifying information defines a color of a frame for each of the variable display sections 3A to 3I.

However, the variable display section identifying information may be any information that defines a property, such as a color, a shape, an image, or a display pattern, of the frame that surrounds each of the variable display sections.

The main CPU 32 that is identification information determination means acquires random numbers for the variable display sections 3A to 3I which are output from the sampling circuit 36 and determines colors of the frames of the variable display sections on the basis of the acquired random numbers. In the embodiment, as the colors of the frames, one color from among four colors of red, blue, yellow, and green is determined. In other words, the main CPU 32 acquires one random number for the variable display section 3A and determines the color of the frame thereof red on the basis of the random number, and similarly, acquires one random number for the variable display section 3B and determines the color of the frame thereof blue. In addition, the CPU 32 acquires random numbers for the remaining variable display sections 3C to 3I and determines the colors thereof. As a result, the colors of the frames of the total nine variable display sections 3A to 3I are determined, respectively.

In the above-described identification information processing, although colors are determined for the whole variable display sections 3A to 3I, a variable display section whose color is not determined may exist. Or, the variable display section whose color is not determined may be regarded as a variable display section whose color is determined to be “no color”. In such case, a variable display section having no frame may be generated, but such a modified form is still within the scope of the present invention.

After the variable display section identifying information determination process (S11), the slot machine 1, more particularly, the main CPU 32, performs a scroll process (S12)

FIG. 7 shows the configuration of a game screen according to an embodiment of the present invention as an example. On the main display 3 of the slot machine 1, the game screen as shown in FIG. 7 is displayed. On the main display 3, the above-described nine variable display sections 3A to 3I are formed. The nine variable display sections 3A to 3I constitute the variable display area 30.

The frames F1 to F9 are displayed for the nine variable display sections 3A to 3I so as to surround the variable display sections. The frames F1 to F9 are not necessarily displayed on the main display 3 continuously. Thus, the frames F1 to F9 may not be displayed at start of a unit game and by performing a variable display section identifying information displaying process (S13 shown in FIG. 5) to be described later, the frames may be in a viewable state.

Above the variable display area 30, a title display unit 83 including a text string for displaying “BONUS-SPIN” and a description of the game is displayed. In addition, below the variable display area 30, a meter display unit 84 having a BET number display section 84a, a PAID number display section 84b, a coin insertion and payout display section 84c, and a CREDIT (credit) number display section 84d is displayed. In addition, eight BET number display sections 82a for displaying the BET numbers for each pay line are disposed so as to surround the variable display sections 3A to 3I.

After the game is started, the scroll process, in which symbols are changed to be displayed on the variable display sections 3A to 3I of the main display 3 as if reels having symbol arrays on their peripheries rotate, is performed in accordance with an instruction of the main CPU 32.

Now, the description of the base game process will be continued with reference back to FIG. 5.

After the scroll process (S12) is performed, the slot machine 1, more particularly, the main CPU 32, performs a variable display section identifying information displaying process (S13). The variable display section identifying information displaying process is a process for displaying the variable display section identifying information on the basis of the result determined in the prior variable display section identifying information determination process (S11). In the embodiment, the slot machine 1, more particularly, the main CPU 32, displays the frames F1 to F9 of the variable display sections 3A to 3I on the main display 3 in colors determined in the variable display section identifying information determination process (S11).

The variable display section identifying information displaying process (S13) is not necessarily performed after start of the scroll process (S12), and, for example, may be performed before the start of the scroll process (S12). Furthermore, the variable display section identifying information displaying process may be configured to be performed after a stop control process (S14), to be described later, is completed.

In the variable display section identifying information displaying process (S13), the colors of the frames F1 to F9 is not necessarily displayed immediately in accordance with the determination performed in the prior variable display section identifying information determination process (S11). For example, when the variable display section identifying information displaying process (S13) is started, the colors of the frames F1 to F9 are periodically changed like red->blue->yellow->green, regardless of the determination of the variable display section identifying information determination process (S11) or are randomly changed among four colors of red, blue, yellow, and green, and when the variable display section identifying information displaying process (S13) is completed, the colors corresponding to the determination of the variable display section identifying information determination process (S11) may be finally displayed.

When the process proceeds to Step 14 after variable display section identifying information displaying process (S13), the slot machine 1, more particularly, the main CPU 32, performs the stop control process (S14). The stop control process (S14) stops the stop symbols, corresponding to the result of the base game lottery process (S10), to be displayed in the variable display sections 3A to 3I while a predetermined representation process such as a process of reducing the speed of scrolling the symbols performed in the above-described scroll process (S12) is performed. When the stop symbols are displayed after Step 14 is completed, the stop control process (S14) ends, and the process proceeds to a special advantage process (S15).

The special advantage process is performed by the main CPU 32 serving as special advantage providing unit according to an embodiment of the present invention. The special advantage process provides a special advantage that is more advantageous in acquisition of the gaming value on the basis of the special variable display section. The special advantage may have various contents so as to increase amusement of the game, achieve continuation or increase of the player's enthusiasm for the game.

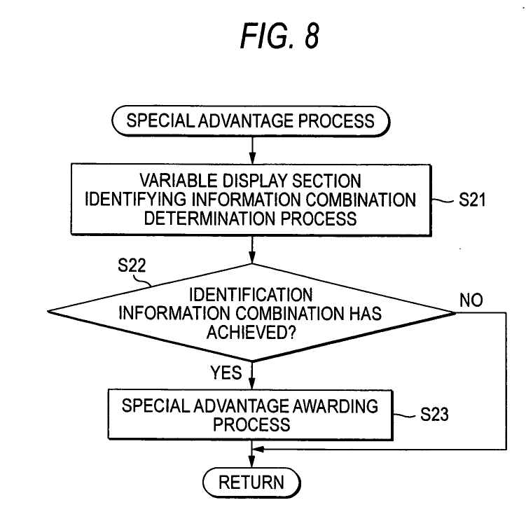

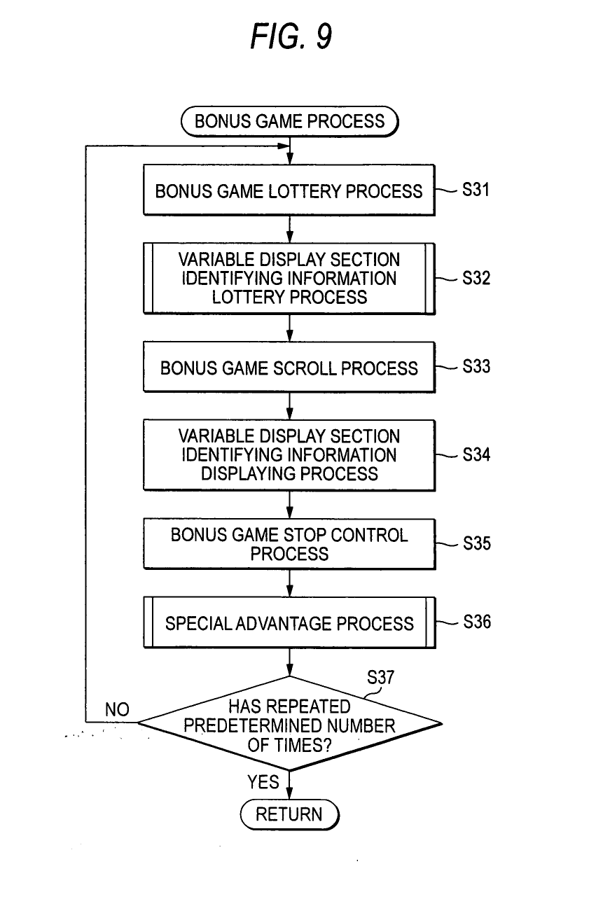

FIG. 8 is a flowchart showing an example of the special advantage process (S15). Hereinafter, an example of the special advantage process will be described with reference to FIG. 8.

When the control proceeds to the special advantage process, the main CPU 32 serving as special advantage awarding means, first, performs a variable display section identifying information combination determination process (S21). The variable display section identifying information combination determination process (S21) is a process for determining whether the colors of the frames F1 to F9, which have been determined in the prior variable display section identifying information lottery process (S11), satisfy an identification information combination that is a condition for awarding the special advantage.

The identification information combination is a combination in a variable display section game and may be any type that can be determined on the basis of the variable display section identifying information.

Examples of the identification information combination are as follows.

(1) Among nine frames F1 to F9, when the number of frames that have a specific color satisfies a predetermined condition, a special advantage is provided. As a specific example, among the frames F1 to F9, when the number of frames that have a red color is equal to or greater than five, two coins are paid out.

(2) When frames of a same color are arranged in a straight line, a special advantage is provided. As a specific example, when all the colors of the frames F1, F2, and F3 of the variable display sections 3A, 3B, and 3C that are arranged in the first row from the top are blue, an award for a blue combination (for example, five coins) is paid out.

(3) The identification information combination may be set in relation with a result of a variable display game. As a specific example, when colors of the frames F1, F4 and F7 of the whole variable display sections (for example, variable display sections 3A, 3D, and 3G arranged in the first column from the left side) for which a winning combination is achieved as a result of a variable display game are the same, a special advantage is provided. The special advantage for such a case may be a payout of a predetermined number of coins or a payout of N (where N is an integer of two or more) times the award for the winning combination achieved in the variable display game.

When the variable display section identifying information combination determination process (S21) is completed, the main CPU 32 serving as special advantage awarding means determines achievement of an identification information combination that is a condition for awarding a special advantage (S22). When it is determined that the identification information combination is not achieved (S22: No), the CPU 32 immediately ends the special advantage process and returns the process back to the original base game process. On the other hand, when it is determined that the identification information combination is achieved (S22: Yes), the CPU 32 serving as the special advantage awarding means performs a special advantage awarding process (S23), then ends the special advantage awarding process, and returns the process back to the original base game process.

The special advantage awarding process (S23) is a process for awarding a special advantage that is an award on the basis of the information identification combination achieved in the variable display section game. The special advantage, as described above, may be any type that is advantageous to a player in a game. Examples of the special advantage are payout of a predetermined number of coins, increasing an award for winning combinations of the variable display game, and the like.

Alternatively, the amount of the special advantage may be changed on the basis of the color. For example, the special advantage may be configured such that 20 coins are paid in a case where the color of the frame is red, 10 coins are paid in a case where the color of the frame is blue, 5 coins are paid in a case where the color of the frame is yellow, and 2 coins are paid in a case where the color of the frame is green.

Alternatively, the special advantage may be awarded on the basis of a stop symbol and the color of the frame of the variable display section displaying the stop symbol. As a specific example, when the color of the frame of a variable display section, on which a “Wild Joker” symbol is displayed as a stop symbol, is red, a special advantage of paying a predetermined number of coins may be provided.

In the above-described example, although the special advantage is provided when the colors of the frames are the same color, however, the condition for awarding the special advantage is not limited thereto, and the special advantage may be awarded when a combination of predetermined colors is achieved.

As the payout in the special advantage process (S15), the main CPU 32 only writes payout information in the RAM 33, and it is not necessary to payout coins by driving the hopper 64 and the like. The actual payout of coins may be performed in a payout process (S5 shown in FIG. 4) to be described later.

Here, the description of the special advantage process is completed, and the description of the base game process (FIG. 5) will be continued. When the special advantage process (S15) is completed, the main CPU 32 ends the base game process and returns the process back to original main process (FIG. 4).

Now, the description of the main process will be continued with reference back to FIG. 4.

When the base game process (S2) ends, the process proceeds to Step 3, and the slot machine 1, more particularly, the main CPU 32, operates as transition determination means. The main CPU 32 performs a transition determination process (S3), in which whether a transition condition for transiting the gaming mode from the base game mode to a bonus game that is a bonus game mode is satisfied is determined on the basis of the result of the symbol determination process in the base game lottery process (S10).

When the slot machine 1, more particularly, the main CPU 32, determines that the transition condition is satisfied, it determines that transition can be made. The transition condition is satisfied, for example, when the stop symbol of the variable display section 3E that is located on the center of the 3×3 matrix is “Wild Joker” 92. Alternatively, the transition condition may be satisfied by a combination of predetermined symbols.

When it is determined that the transition condition in the above example is satisfied (S3: Yes), an image (center Joker image) in which “Wild Joker” 92 is displayed as the stop symbol of the variable display section 3E and an image representing a message of “GET THE SPECIAL BONUS!!” are displayed on the main display 3. In addition, the main CPU 32 operates as a transition unit and shifts the gaming mode to the bonus game mode. When the gaming mode is transited to the bonus game mode, the process proceeds to Step 4, and a bonus game process (S4) is performed.

FIG. 8 shows a flowchart representing an example of the bonus game process. Hereinafter, the bonus game process will be described with reference to FIG. 8.

Although the bonus game is described as a predetermined number (for example, ten times) of free games in this example for the description of the bonus game process, a bonus game provided by the slot machine 1 according to an embodiment of the present invention is not limited thereto, and any other game that provides a bonus game advantageous to the player may be provided as the bonus game.

When the bonus game process (S4) is started, the slot machine 1, more particularly, the main CPU 32, sequentially performs a bonus game lottery process (S31), a variable display section identifying information lottery process (S32), a bonus game scroll process (S33), a variable display section identifying information displaying process (S34), a bonus game stop control process (S35), and a special advantage process (S36) By performing the processes from the bonus game lottery process (S31) to the special advantage process (S36), performing of one free game is completed.

Since the bonus game lottery process (S31), the variable display section identifying information lottery process (S32), the bonus game scroll process (S33), the variable display section identifying information displaying process (S34), the bonus game stop control process (S35), and the special advantage process (S36) are the same as the base game lottery process (S10), the variable display section identifying information lottery process (S11), the scroll process (S12), the variable display section identifying information displaying process (S13), the stop control process (S14), and the special advantage process (S15) of the base game process (S2), detailed descriptions thereof are omitted here.

After the special advantage process (S35) of the bonus game process is performed, the slot machine 1, more particularly, the main CPU 32, determines whether free games are performed a predetermined number of times (S37). When it is determined that the free games are performed for the predetermined number of times (S37: Yes), the slot machine 1, more particularly, the main CPU 32, ends the bonus game process and returns the process back to the main process. On the other hand, when it is determined that the free games are not performed for the predetermined number of times (S37: No), the slot machine 1, more particularly, the main CPU 32, returns the process back to the bonus game lottery process (S31) so as to continue to perform the bonus game process for performing the free games for the remaining number of times, and continues to perform the bonus game process.

Here, the description of the bonus game process is completed.

Next, an example of a screen displayed on the main display 3, and more particularly, an example of display in the variable display section game will be described as a description of an example of the operation of the slot machine 1. Since display of the screen in the variable display game is the same as that of a conventional slot machine, a description of an example of a screen in the variable display game is omitted here.

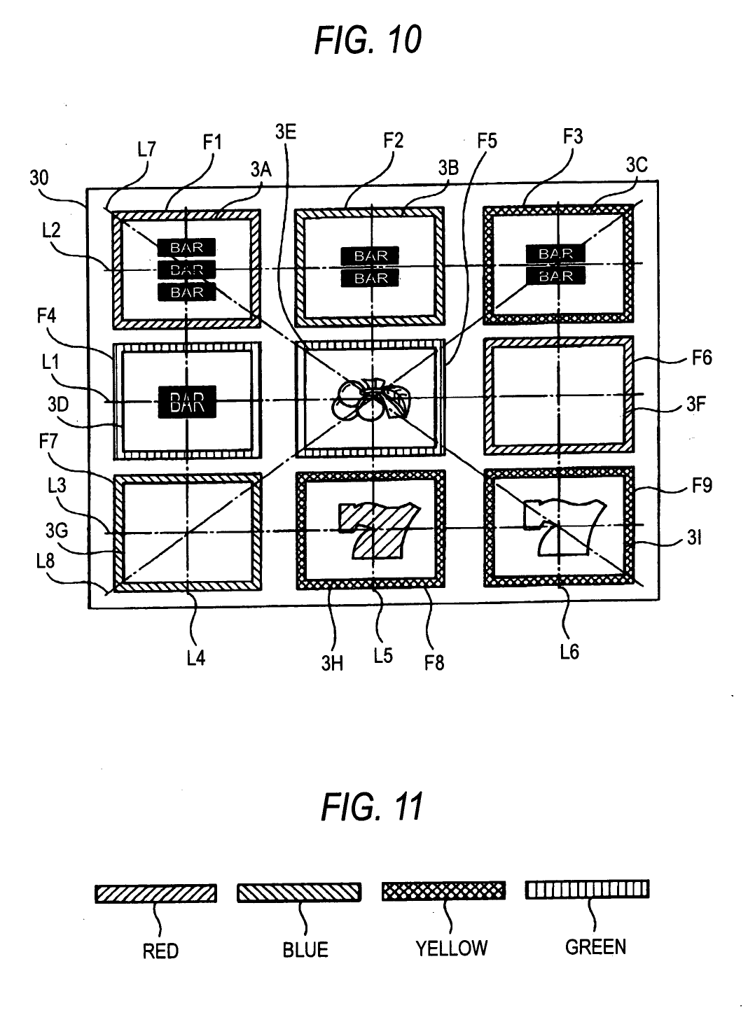

FIG. 10 is a partially enlarged diagram of a screen (see FIG. 7) displayed on the main display 3 in the base game process and shows a variable display area 30. The screen shown in FIG. 10 is an example of a screen in a state that the variable display section identifying information displaying process (S13) and the stop control process (S14) are completed in the base game process. On the variable display sections 3A to 3I, stop symbols are displayed, and the frames F1 to F9 that are variable display section identifying information are displayed so as to surround the corresponding variable display sections.

On the screen shown in FIG. 10, the colors of the frames F1 to F9 that are variable display section identifying information determined in the variable display section identifying information lottery process (S11) are displayed. In the example shown in the figure, as a result determined in the variable display section identifying information lottery process (S11), the frame F1 surrounding the variable display section 3A is red, the frame F2 surrounding the variable display section 3B is blue, the frame F3 surrounding the variable display section 3C is yellow, the frame F4 surrounding the variable display section 3D is green, the frame F5 surrounding the variable display section 3E is green, the frame F6 surrounding the variable display section 3F is red, the frame F7 surrounding the variable display section 3G is red, the frame F8 surrounding the variable display section 3H is yellow, and the frame F9 surrounding the variable display section 3I is yellow. On the main display 3, the colors of the frames F1 to F9 are displayed in accordance with the lottery result determined in the variable display section identifying information lottery process (S11).

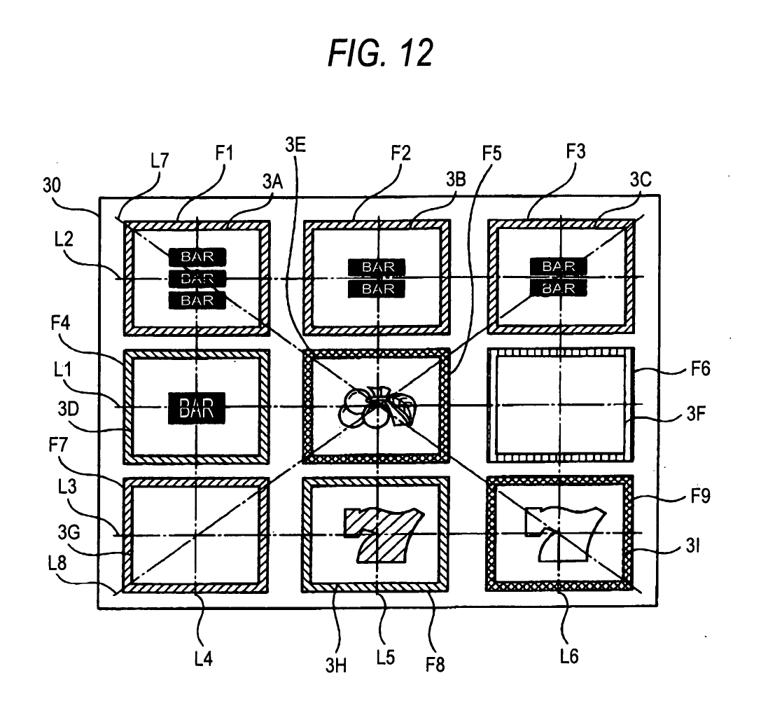

FIG. 11 is a diagram showing hatchings denoted in the frames shown in FIG. 10 and colors indicated by the hatchings. The relationship between the hatchings and colors shown in FIG. 11 also applies in FIGS. 12 to 14 to be described later.

Next, a plurality of examples for achievement of the identification information combination in a variable display section game of the slot machine 1 will be described.

FIG. 12 is a partially enlarged diagram of a screen (see FIG. 7) displayed on the main display 3 in the base game process and shows a variable display area 30 according to a first example. In this example, a case where the frames of a same color are aligned in a line (a vertical, horizontal, or diagonal line) is determined to satisfy an identification information combination.

In the screen shown in FIG. 12, as a result determined in the variable display section identifying information lottery process (S11), the frame F1 surrounding the variable display section 3A is red, the frame F2 surrounding the variable display section 3B is red, the frame F3 surrounding the variable display section 3C is red, the frame F4 surrounding the variable display section 3D is blue, the frame F5 surrounding the variable display section 3E is yellow, the frame F6 surrounding the variable display section 3F is green, the frame F7 surrounding the variable display section 3G is red, the frame F8 surrounding the variable display section 3H is blue, and the frame F9 surrounding the variable display section 3I is yellow. On the main display 3, the colors of the frames F1 to F9 are displayed in accordance with the lottery result determined in the variable display section identifying information lottery process (S11). The colors indicated by hatchings denoted in the frames are as shown in FIG. 11.

In the example shown in FIG. 12, the frames of the variable display sections 3A, 3B, and 3C forming the top horizontal line have a same color aligned. Thus, the main CPU 32, which is the special advantage awarding means, determines that an identification information combination is achieved in the state shown in FIG. 12 and awards a predetermined special advantage.

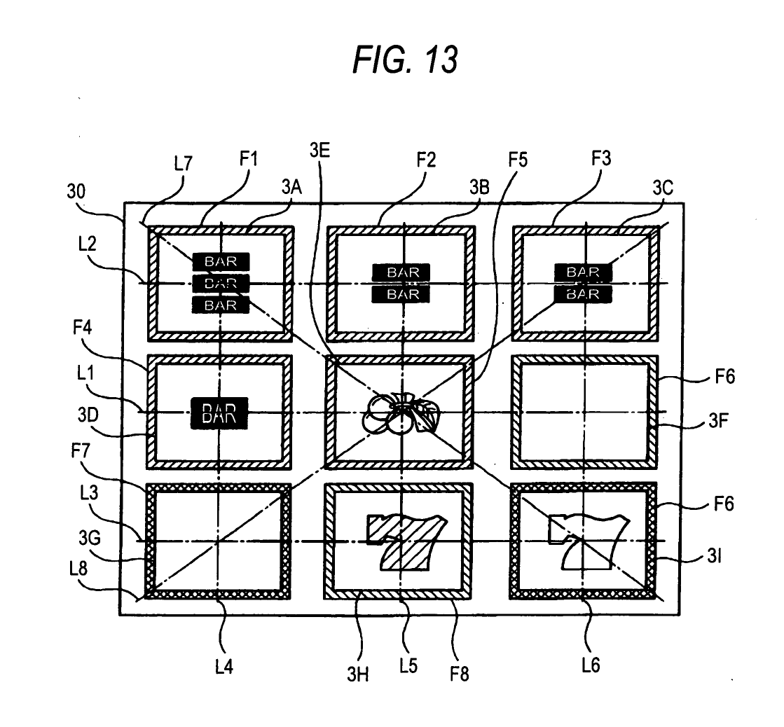

In FIG. 13, a second example for achievement of the identification information combination in the variable display section game of the slot machine 1 other than the example shown in FIG. 12 is shown. FIG. 13 is a partially enlarged diagram of a screen (see FIG. 7) displayed on the main display 3 in the base game process and shows a variable display area 30. In this example, a case where the number of the displayed frames having a same color is equal to or greater than a predetermined number (for example, five) is determined to satisfy an identification information combination.

In the screen shown in FIG. 13, as a result determined in the variable display section identifying information lottery process (S11), the frame F1 surrounding the variable display section 3A is red, the frame F2 surrounding the variable display section 3B is red, the frame F3 surrounding the variable display section 3C is red, the frame F4 surrounding the variable display section 3D is red, the frame F5 surrounding the variable display section 3E is red, the frame F6 surrounding the variable display section 3F is blue, the frame F7 surrounding the variable display section 3G is yellow, the frame F8 surrounding the variable display section 3H is blue, and the frame F9 surrounding the variable display section 3I is yellow. On the main display 3, the colors of the frames F1 to F9 are displayed in accordance with the lottery result determined in the variable display section identifying information lottery process (S11).

In the example shown in FIG. 13, among nine frames F1 to F9, five frames F1 to F5 have the same color of red. Thus, the main CPU 32, which is the special advantage awarding means, determines that an identification information combination is achieved in the state shown in FIG. 13 and awards a predetermined special advantage.

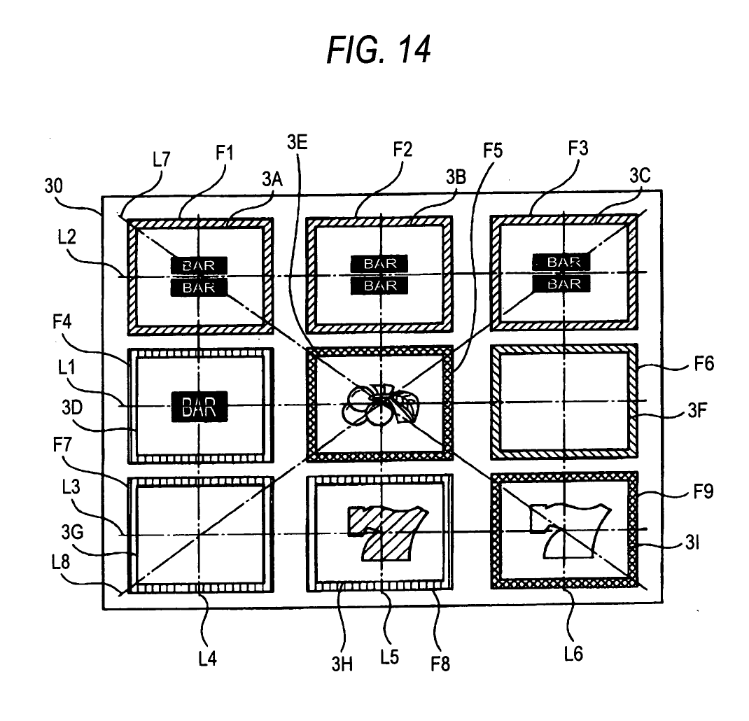

In FIG. 14, a third example for achievement of the identification information combination in the variable display section game of the slot machine 1 other than the examples shown in FIGS. 12 and 13 is shown. FIG. 14 is a partially enlarged diagram of a screen (see FIG. 7) displayed on the main display 3 in the base game process and shows a variable display area 30. In this example, a case where the colors of the whole variable display sections that have achieved a winning combination of the variable display game are the same is determined to satisfy an identification information combination.

In the screen shown in FIG. 14, a lottery result of the variable display section identifying information lottery process (S11) is determined as follows. The frame F1 surrounding the variable display section 3A is red, the frame F2 surrounding the variable display section 3B is red, the frame F3 surrounding the variable display section 3C is red, the frame F4 surrounding the variable display section 3D is green, the frame F5 surrounding the variable display section 3E is yellow, the frame F6 surrounding the variable display section 3F is blue, the frame F7 surrounding the variable display section 3G is green, the frame F8 surrounding the variable display section 3H is green, and the frame F9 surrounding the variable display section 3I is yellow. On the main display 3, by performing the variable display section identifying information lottery process (S13), the colors of the frames F1 to F9 are displayed in accordance with the lottery result determined in the variable display section identifying information lottery process (S11).

In the example shown in FIG. 14, the stop symbols of variable display sections 3A, 3B, and 3C aligned on the top horizontal line are “double bar” symbol, whereby a winning combination “double bar” of the base game is achieved in the variable display sections 3A, 3B, and 3C. The colors of the frames F1, F2, and F3 of the variable display sections 3A, 3B, and 3C for which the winning combination of the base game is achieved are the same color of “red”. Thus, the main CPU 32, which is the special advantage awarding means, determines that an identification information combination is achieved in the state shown in FIG. 14 and awards a predetermined special advantage.

The above-described embodiment may be modified as follows.

(1) In the above-described embodiment, although nine variable display sections are provided, the number of the variable display sections is not limited thereto, and may be an arbitrary number such as three or five. In addition, the variable display sections are not necessarily to be disposed in a matrix, and any disposition pattern (for example, a concentric shape, a hive shape, or the like) may be used. Furthermore, the variable display sections may be displayed in one line by being vertically aligned in one row (for example, when the number of the variable display sections is three).

As described in the above with reference to the embodiment, there is provided a gaming machine that includes: a display; an operation unit that allows a player to input commands for playing a game; and a processor that operates to: control the display to perform a variable display of a plurality of symbols in each of a plurality of variable display sections that are arranged in matrix, when a start command is input through the operation unit; perform a lottery to determine stop symbols to be displayed stopped in the variable display sections; control the display to display the stop symbols in the variable display sections after performing the variable display; determine whether or not a symbol combination of the stop symbols satisfies a winning combination; provide an award to the player when determined that the symbol combination of the stop symbols satisfies the winning combination; determine variable display section identifying information for each of the variable display sections; provide a special award to the player based on the determined variable display section identifying information, the special award being

There is also provided a gaming machine that includes: a plurality of variable display sections (for example, reels or the like) that display stop symbols after variably displaying a plurality of symbols; a lottery means (for example, a main CPU or the like) for performing a lottery for determining the stop symbols to be displayed on the plurality of variable display sections; a determination means (for example, a main CPU or the like) for determining whether the stop symbols displayed on the plurality of variable display sections include a symbol combination forming a winning combination on the basis of the stop symbols drawn in the lottery performed by the lottery means; an award providing means (for example, a main CPU or the like) for providing an award corresponding to the winning combination when the determination means have determined that the stop symbols displayed on the plurality of variable display sections include the symbol combination forming the winning combination; a determination means for determining variable display section identifying information (for example, frames of the variable display sections or the like) related to the plurality of variable display sections; and a special advantage awarding means (for example, a main CPU or the like) for providing a special advantage advantageous to a player on the basis of the variable display section identifying information determined by the determination means.

In the gaming machine, the variable display section identifying information is information related to the variable display sections, and for example, the variable display sections and the variable display section identifying information related to the variable display sections may have a one to one correspondence. In order to enable the player to recognize the relationship between the variable display section identifying information and the variable display sections, the position relationship (for example, the related variable display section and the variable display section identifying information may be disposed closely) between the variable display sections and the variable display section identifying information related to the variable display sections may be used, or information (a number, a symbol, a shape, a texture pattern, or the like) indicating the relationship therebetween may be assigned to both of them.

The variable display section identifying information includes a plurality of types of elements that can be separately identified. For example, when the variable display section identifying information is frames disposed to surround the variable display sections, a plurality of types of frames such as a red frame, a blue frame, a yellow frame, and a green frame becomes the variable display section identifying information. The above-described determination means selects one type for each variable display section from among the plurality of types of variable display section identifying information and determines the selected type as the variable display section identifying information related to the variable display sections.

This variable display section identifying information is used for determining on special advantage awarding/achievement. For example, when the variable display section identifying information (the number of variable display section identifying information is the same as that of the variable display sections) determined by the determination means forms a predetermined combination or a predetermined pattern (for example, forms an identification information combination), a special advantage is provided.

The special advantage may be any type that is advantageous to a player in a game. Examples of the special advantage are payout of a predetermined number of coins, making an award N times.

In this gaming machine, the player can enjoy a game on the basis of variable display section identifying information in addition to a game on the basis of the stop symbols of the variable display sections, and thus excitement of the game increases. In addition, since the player can acquire an award of the game on the basis of the variable display section identifying information in addition to an award of the game on the basis of the stop symbols of the variable display sections, enthusiasm of the player for the game increases, whereby improvement of the operating rate of the gaming machine can be expected.

In the gaming machine, frames surrounding the plurality of variable display sections may be used as the variable display section identifying information. In such a case, since the player can simultaneously watch both the stop symbols displayed on the variable display sections and the frames that are used as variable display section identifying information without moving his sight, it is possible for the player to simultaneously enjoy the game on the basis of the stop symbols of the variable display sections and the game on the basis of the variable display section identifying information.

In addition, an area for displaying the variable display section identifying information is not needed to be separately provided in addition to an area for displaying the variable display sections, it is possible to provide a game using the variable display section identifying information without acquiring a relatively large display area.

In the gaming machine, the variable display section identifying information may be color frames surrounding the plurality of variable display sections, and the special advantage awarding means may award the special advantage on the basis of at least one between colors of the frames and a disposition pattern of the frames.

### Advantage of the Invention

According to an embodiment of the present invention, a special advantage is provided to a player on the basis of a variable display section identifying information in addition to payouts for the winning combinations of base games or the like, and accordingly, it is possible to further improve the enthusiasm of the player for the game.

The present invention may be applied to any kind of gaming machines that variably displays a plurality of symbols, such as a slot machine, a pachinko machine, or other gaming machines.

What is claimed is:

1. A gaming machine comprising:
a display;
an operation unit that allows a player to input commands for playing a game; and
a processor that operates to:
control the display to perform a variable display of a plurality of symbols in each of a plurality of variable display sections that are arranged in matrix, when a start command is input through the operation unit;
perform a lottery to determine stop symbols to be displayed stopped in the variable display sections;
control the display to display the stop symbols in the variable display sections after performing the variable display;
determine whether or not a symbol combination of the stop symbols satisfies a winning combination;
provide an award to the player when determined that the symbol combination of the stop symbols satisfies the winning combination;
determine variable display section identifying information for each of the variable display sections;
provide a special award to the player based on the determined variable display section identifying information, the special award being advantageous to the player.

2. The gaming machine according to claim 1, wherein the variable display section identifying information is information that defines a property of a frame that surrounds each of the variable display sections.

3. The gaming machine according to claim 2, wherein the variable display section identifying information is information that defines a color of the frame that surrounds each of the variable display sections.

4. The gaming machine according to claim 3, wherein the processor provides the special award based on at least one of (1) the color of the frame defined by the variable display section identifying information for each of the variable display sections and (2) an arrangement pattern of the frame having same property defined by the variable display section identifying information for each of the variable display sections.

5. The gaming machine according to claim 2, wherein the processor provides the special award based on an arrangement pattern of the frame having same property defined by the variable display section identifying information for each of the variable display sections.

6. A gaming machine comprising:
a plurality of variable display sections that display stop symbols after variably displaying a plurality of symbols;
a lottery means for performing a lottery for determining the stop symbols to be displayed in the plurality of variable display sections;
a determination means for determining whether or not the stop symbols displayed on the plurality of variable display sections include a symbol combination forming a winning combination on the basis of the stop symbols determined by the lottery means;
an award providing means for providing an award corresponding to the winning combination when the determination means determines that the stop symbols displayed on the plurality of variable display sections include the symbol combination forming the winning combination;
a determination means for determining variable display section identifying information for each of the plurality of variable display sections; and
a special advantage awarding means for providing a special advantage that is advantageous to a player on the basis of the variable display section identifying information determined by the determination means.

7. The gaming machine according to claim 6, wherein the variable display section identifying information is information that defines a property of a frame that surrounds each of the variable display sections.

8. The gaming machine according to claim 6, wherein the variable display section identifying information is information that defines a color of a frame that surrounds each of the variable display sections, and
wherein the special advantage awarding means provides the special advantage on the basis of at least one of (1) the color of the frame defined by the variable display section identifying information for each of the variable display sections and (2) an arrangement pattern of the frame having same property defined by the variable display section identifying information for each of the variable display sections.
